(19) United States
(12) Patent Application Publication
(10) Pub. No.: US 2025/0137880 A1
(43) Pub. Date: May 1, 2025

(54) A METHOD FOR SELECTING A CANDIDATE BEARING COMPONENT TO BE RE-MANUFACTURED

(71) Applicant: AKTIEBOLAGET SKF, GOTEBORG (SE)

(72) Inventors: Predrag ANDRIC, Zeist (NL); Antonio GABELLI, Ijsselstein (NL); Sebastien BLACHERE, Den Haag (NL)

(21) Appl. No.: 18/849,059

(22) PCT Filed: Mar. 7, 2023
(86) PCT No.: PCT/EP2023/055699

§ 371 Date: Sep. 20, 2024

(30) Foreign Application Priority Data
Mar. 29, 2022 (DE) 102022203073.7

(51) Int. Cl. G01M 13/04

(52) U.S. Cl. CPC G01M 13/04

(57) ABSTRACT

A method for selecting a candidate bearing component to be re-manufactured includes performing a non-destructive inspection of at least one portion of a bearing component to detect sub-surface damages in the at least one portion and obtain a result indicative of an effective damage in the at least one portion, calculating a remaining life of the bearing component based on a predetermined load value and on the result indicative of the effective damage in the at least one portion, and selecting the bearing component as the candidate bearing component to be re-manufactured if the calculated remaining life is within a predefined range. The remaining life is calculated from the formula: N=c*D^{α}, where N is the remaining life until reaching end of life of the bearing component, c is a first constant value associated with the predetermined load value, D is the effective damage and α is a second constant value.

### TECHNICAL FIELD

The present disclosure relates to a method for selecting a candidate bearing component to be re-manufactured. In addition, the present disclosure relates to a method for re-manufacturing a bearing component and to a bearing component.

### BACKGROUND

Bearings, such as roller bearings and ball bearings, are machine elements which are used in many different industrial applications. By way of example, a bearing may comprise several different bearing components which are subjected to loads during use. The bearing components which are subjected to load are typically an inner ring, an outer ring and a plurality of rolling elements, i.e. rollers and/or balls.

The service life of a bearing is dependent on a number of different factors. For example, the service life of a bearing may be dependent on the load exerted on the bearing during use, the material properties of the bearing and on the type of bearing. For a specific bearing, the weakest component of the bearing, i.e. the component which will break first, typically determines the service life of the bearing.

In order to extend the service life of a bearing it is known to re-manufacture the complete bearing, or at least to re-manufacture certain components of the bearing. For example, a raceway surface of an inner or outer ring may be re-machined to thereby obtain a re-machined raceway surface. Thereby, a worn raceway surface may be removed. As a consequence, the service life of the bearing can be extended.

Re-manufacturing of bearings has shown to be a cost-efficient and environmentally friendly approach to extend the service life of a bearing. More specifically, re-manufacturing can result in less waste and lower cost for the user.

However, not all bearings are suitable for re-manufacturing. For example, a bearing component may be damaged to an extent so that re-manufacturing would not significantly extend the service life.

Therefore, in view of the above, there is a strive to develop technology which can select which bearing, and/or which bearing component, that is a good candidate for re-manufacturing. In addition, there is also a strive to develop improved methods for estimating bearing life.

### SUMMARY

In view of the above, an object of the disclosure is to provide a method for selecting a candidate bearing component to be re-manufactured. More specifically, an object of the invention is to provide an improved method for selecting a candidate bearing component to be re-manufactured, or at least to provide a suitable alternative. Other objects of the disclosure are to provide an improved method for re-manufacturing a bearing component, an improved bearing component, an improved bearing, and/or an improved method for calculating a remaining bearing life, or at least to provide suitable alternatives.

According to a first aspect of the disclosure, at least one object is at least partly achieved by a method according to claim 1.

Thus, there is provided a method for selecting a candidate bearing component to be re-manufactured. The method comprises:
performing a non-destructive inspection of at least one portion of a bearing component, wherein the non-destructive inspection comprises detecting sub-surface damages in the at least one portion, thereby obtaining a result indicative of an effective damage in the at least one portion,
calculating a remaining life of the bearing component based on a predetermined load value and on the result indicative of the effective damage in the at least one portion, and
selecting the bearing component as the candidate bearing component to be re-manufactured when the calculated remaining life is within a predefined range.

By sub-surface damages is herein meant damages which are at least partly located below the surface, or damages which are completely located below the surface, e.g. damages which are not visible on the surface. A damage may also be denoted a crack.

A load value as used herein may in some embodiments be denoted a contact pressure, i.e. a contact pressure exerted on a surface of the bearing component.

By the provision of a method according to the first aspect as disclosed herein, an improved method for selecting a candidate bearing component to be re-manufactured is achieved. More specifically, it has been realized that it is advantageous to obtain a value of a remaining life as proposed herein in order to decide if the bearing component is suitable for re-manufacturing or not. Typically, during re-manufacturing, a surface of the bearing component is treated to remove any damages thereon. As such, all or most of any sub-surface damages will likely not be removed by a re-manufacturing process. Therefore, by estimating the remaining life based on detected sub-surface damages as proposed herein, it can be better assessed if it would be worthwhile to re-manufacture the bearing component or not. Hence, if the remaining life calculation indicates that the detected sub-surface damages are too severe, it can be decided to not re-manufacture the bearing component. On the other hand, if the remaining life calculation indicates that the detected sub-surface damages are not too severe, the bearing component can be selected as a candidate for re-manufacturing. Accordingly, when the calculated remaining life is within the predefined range, the bearing component is judged as suitable for re-manufacturing. According to an example embodiment, the predefined range may further be associated with a cost for re-manufacturing the specific type of bearing component or bearing. Accordingly, by way of example, the bearing component may be selected as the candidate bearing component to be re-manufactured when the calculated remaining life and an expected cost for re-manufacturing is within a predefined range for the specific type of bearing component, or for the specific type of bearing. Thereby, by means of the method, a more cost-efficient approach to select which bearing components that should or should not be re-manufactured may be achieved. Accordingly, this implies a more cost-efficient bearing component manufacturing procedure.

In addition, it has further been realized that it is advantageous to base the remaining life calculation on detected sub-surface damages in the at least one portion. More specifically, by detecting sub-surface damages, a more reliable and accurate remaining life calculation can be performed. The sub-surface damage inspection and remaining life calculation has also shown to be a cost efficient and time efficient approach for calculating a remaining life of a bearing component. For example, the method has shown to be flexible for calculating the remaining life at different contact pressures, for different steels and/or heat treatments of the bearing component.

Optionally, each detected sub-surface damage is associated with a depth below the surface and a voluminal size of the damage. This implies a more reliable and accurate remaining life calculation. Still optionally, the result indicative of the effective damage is obtained by summing all the voluminal sizes of the damages multiplied by an associated weight factor, wherein the associated weight factor is dependent on the depth and size of each damage. By way of example, the weight factor may be proportional to sub-surface stress distribution over depth, such as sub-surface shear stress distribution over depth, sub-surface normal stress distribution over depth and/or sub-surface residual stress distribution over depth. Additionally, or alternatively, the weight factor may depend on the fracture toughness of the material of the bearing component, and/or the weight factor may depend on a type of heat treatment applied to the bearing component. For example, a higher fracture toughness may provide a higher resistance to damage expansion. With respect to the size, the weight factor is typically proportional to the size indication of the damage, i.e. the larger the size indication is, the larger the weight factor is. This implies that damages with larger size tend to be more dangerous than damages which are smaller in size. The weight factor is typically also proportional to the depth.

Optionally, the non-destructive inspection may be an ultrasonic inspection of the bearing component. Other non-destructive techniques may also be used, such as radiographic based techniques, laser-based techniques, or any other non-destructive inspection method known by the skilled person.

Optionally, the step of performing non-destructive inspection is performed for a plurality of portions of the bearing component, such as for a plurality of portions associated with a raceway surface of the bearing component, wherein the remining bearing life calculation is done for the portion having a maximum effective damage. This implies a more reliable and accurate remaining life calculation. More specifically, by inspecting a plurality of portions and therefrom use the portion with the maximum effective damage for the remining bearing life calculation, the result will better reflect the actual remaining life of the bearing component.

Optionally, the remaining life is calculated based on the following formula:

$$N = {c}^{⋆} {D}^{α}$$

wherein N is the remaining life, such as a remaining number of predicted revolutions, until reaching end of life of the bearing component, c is a first constant value associated with the predetermined load value, D is the effective damage and a is a second constant value.

Optionally, the constant values, c and a, are obtained empirically by:
performing the step of non-destructive inspection for a plurality of test bearing components under known and different load conditions and for test bearing components with different initial sub-surface damage, and,
measuring remaining life for the plurality of test bearing components by testing the plurality of test bearing components until sub-surface failure occurs.

Thereby, remaining life for different load conditions as a function of effective damage can be obtained. This may be plotted as curves for different load conditions. Optionally, the curves may be provided by interpolation between the empirically obtained values, and/or by use of a polynomial curve fit on the empirically obtained values.

Optionally, the non-destructive inspection for each test bearing component is performed before, during and after the respective component has been tested, thereby obtaining results indicative of an effective damage of each test bearing component before, during and after each test. This implies that more relevant data is provided for obtaining the remaining bearing life calculation formula.

According to a second aspect of the disclosure, at least one object is at least partly achieved by a method according to claim 9.

Thus, there is provided a method for re-manufacturing a bearing component. The method comprises:
performing the method according to any one of the embodiments of the first aspect of the disclosure for a bearing component, and
when the bearing component is selected as a candidate bearing component to be re-manufactured, re-manufacturing the selected bearing component, such as re-manufacturing a raceway surface of the selected bearing component.

Thereby, a re-manufactured bearing component will be provided for which the remaining life will be extended as a consequence of the re-manufacturing.

Re-manufacturing may for example comprise machining a raceway surface of the bearing component. For example, the machining operation may comprise at least one of grinding, honing, superfinishing and polishing.

According to a third aspect of the disclosure, at least one object is at least partly achieved by a bearing component according to claim 10.

Thus, there is provided a bearing component, such as a bearing ring or roller, wherein the bearing component has been subjected to a re-manufacturing method according to any one of the embodiments of the second aspect of the disclosure.

Thereby, a re-manufactured bearing component is provided, implying increased service life and cost-efficiency.

According to a fourth aspect of the disclosure, there is provided a bearing, wherein the bearing comprises a bearing component according to any one of the embodiments of the third aspect of the disclosure.

For example, the bearing may be a ball bearing or roller bearing, including but not limited to a spherical roller bearing, a tapered roller bearing, a toroidal roller bearing, a cylindrical roller bearing, a spherical ball bearing, a deep groove ball bearing and an angular contact ball bearing. Alternatively, the bearing may be a plain bearing, such as a spherical plain bearing. The bearing may be a bearing for any type of industrial application, such as but not limited to pulp and paper applications, wind turbines, metal and mining industry applications, railway applications, automotive applications etc. Additionally, or alternatively, the bearing may be of different sizes, such as a large-size bearing and a mid-size bearing. A large-size bearing may be defined as a bearing with an outer diameter being greater than 500 mm and a mid-size bearing may be defined as a bearing with an outer diameter of 100-500 mm.

According to a fifth aspect of the disclosure, at least one object is at least partly achieved by a method for calculating remaining life of a bearing component.

The method according to the fifth aspect comprises:
performing a non-destructive inspection of at least one portion of a bearing component, wherein the non-destructive inspection comprises detecting sub-surface damages in the at least one portion, thereby obtaining a result indicative of an effective damage in the at least one portion, and
calculating a remaining life of the bearing component based on a predetermined load value and on the result indicative of the effective damage in the at least one portion.

Advantages and effects of the fifth aspect of the disclosure are largely analogous to the advantages and effects of the first aspect of the disclosure, and vice versa. It shall also be noted that all embodiments of the first aspect of the disclosure are applicable to and combinable with all embodiments of the fifth aspect of the disclosure, and vice versa.

For example, the method for calculating remaining life as disclosed herein may also be used for any one of the following: an already re-manufactured bearing component, a used bearing component and an unused bearing component. Thereby, a reliable and accurate remaining life value may be obtained in a cost efficient and time efficient manner.

The remaining life calculation may advantageously be used for quality control in production, e.g. by inspecting the bearing component after it has been produced and calculate its remaining life according to the method as disclosed herein. Accordingly, as an example, the bearing component may be selected as quality approved if the calculated remaining life is within a predetermined quality range. In addition, the method for calculating remaining life of a bearing component may be done as part of a predictive maintenance operation, e.g. by performing sub-surface inspection during use of the bearing component. Accordingly, it may be decided to perform maintenance of the bearing component if the calculated remaining life is within a predetermined maintenance range. Still further, by the method for calculating remaining life of a bearing component, time for testing may be shortened. This implies reduced energy consumption and increased test rig availability.

### BRIEF DESCRIPTION OF THE DRAWINGS

The present disclosure will hereinafter be further explained by means of non-limiting examples with reference to the appended schematic figures where;

FIG. 1 is a schematic view of a rolling bearing according to an example embodiment of the present disclosure,

FIG. 2 is a graph showing a remaining life of a bearing component or bearing as a function of effective damage according to an example embodiment of the present disclosure,

FIG. 3 is a schematic and sectional view of a portion of a bearing component with sub-surface damages, and

FIGS. 4a and 4b show flowcharts of methods according to example embodiments of the present disclosure.

It should be noted that the drawings have not necessarily been drawn to scale and that the dimensions of certain features may have been exaggerated for the sake of clarity.

Further advantages and advantageous features of the disclosure are disclosed in the following description and in the dependent claims.

### DETAILED DESCRIPTION

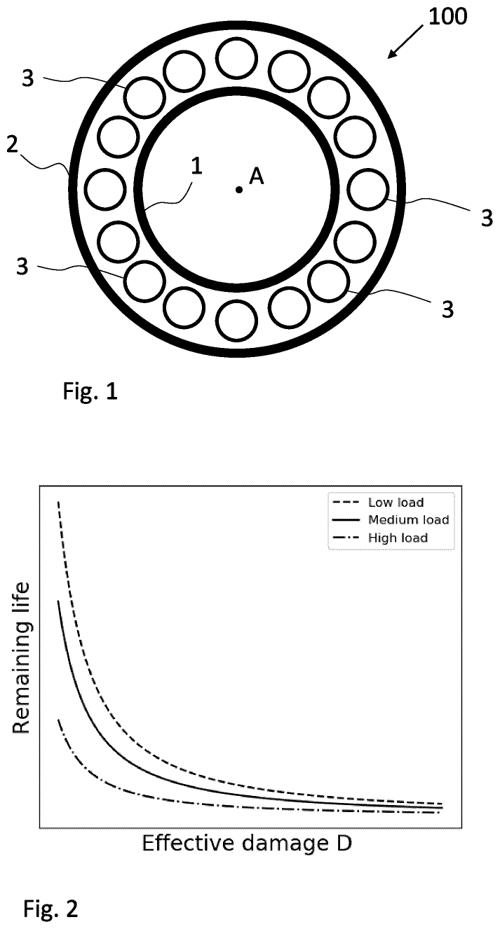

FIG. 1 depicts a schematic view of a bearing 100, which in this example is a rolling bearing. The bearing 100 comprises a plurality of bearing components. More specifically, the bearing 100 comprises an inner ring 1, an outer ring 2 and a plurality of rolling elements 3 interposed in-between the inner ring 1 and the outer ring 2. The rolling elements may be balls, rollers, or a combination thereof. The bearing 100 may also comprise one or more cages (not shown) for supporting and guiding the rolling elements 3 during use. The rings 1, 2 and the rollers 3 are adapted to rotate with respect to a rotational axis A.

With reference to FIG. 4a, a method according to the first aspect of the disclosure will be described in more detail.

The method is a method for selecting a candidate bearing component to be re-manufactured. Accordingly, any one of the inner ring 1, the outer ring 2 and at least one rolling element 3 may, by use of the method, be selected as a candidate bearing component to be re-manufactured.

The method comprises:

S1: performing a non-destructive inspection of at least one portion 10 of a bearing component 1, wherein the non-destructive inspection comprises detecting sub-surface damages 12 in the at least one portion 10, thereby obtaining a result indicative of an effective damage D in the at least one portion 10.

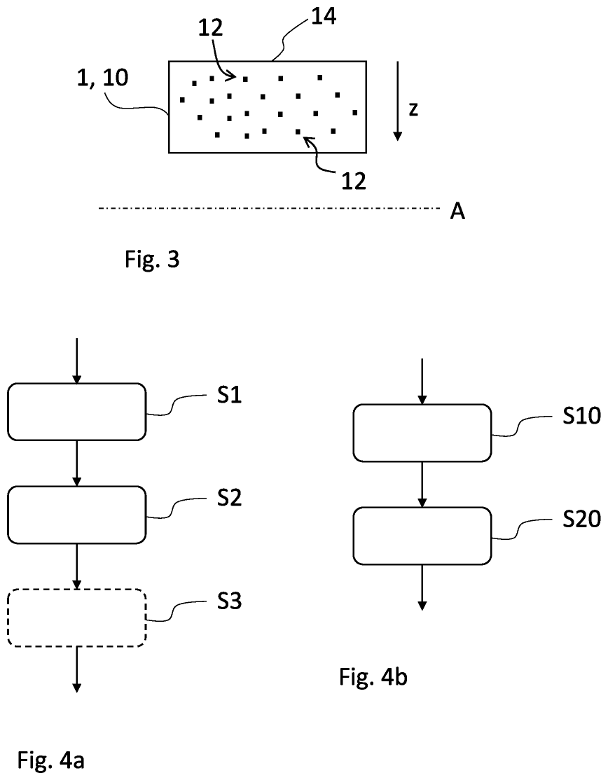

An example of a portion 10 is shown in FIG. 3, depicting a cross-section of the portion 10. The portion 10 is here a portion of the inner ring 1 as shown in FIG. 1. In the shown example, the cross-section corresponds to a plane defined by the rotational axis A of the inner ring 1. In other words, at least two separate points of the rotational axis A are provided in the plane.

As shown, the portion 10 comprises a plurality of sub-surface damages 12. These sub-surface damages 12 have been detected by the non-destructive inspection and are provided below a surface 14. The surface 14 is herein a raceway surface for the bearing component 1, i.e. the surface onto which the rolling elements 3 are intended to roll. As mentioned in the above, the non-destructive inspection may be an ultrasonic inspection or any other type of non-destructive inspection which can detect sub-surface damages 12.

The method further comprises:
S2: calculating a remaining life of the bearing component 1 based on a predetermined load value and on the result indicative of the effective damage D in the at least one portion 10, and
S3: selecting the bearing component 1 as the candidate bearing component to be re-manufactured when the calculated remaining life is within a predefined range.

Preferably, the predefined range may further be associated with a cost for re-manufacturing the specific type of bearing component or bearing. Accordingly, by way of example, the bearing component may be selected as the candidate bearing component to be re-manufactured when the calculated remaining life and an expected cost for re-manufacturing is within a predefined range for the specific type of bearing component, or for the specific type of bearing. Accordingly, the predefined range may be set in dependence on at least one of the type of bearing, the size of the bearing, current prize level of the bearing etc. For example, the predefined range may vary over time, e.g. as a consequence of varying price levels of raw material.

As shown in FIG. 3, each detected sub-surface damage 12 is preferably associated with a depth z below the surface 14 and a voluminal size of the damage 12. For example, the result indicative of the effective damage may be obtained by summing all the voluminal sizes of the damages 12 multiplied by an associated weight factor, wherein the associated weight factor is dependent on the depth z and size of each damage 12. The associated weight factor may further be dependent on the fracture toughness of the material of the bearing component 1. Typically, the weight factor is inversely proportional to the fracture toughness of the material. This means that increase of the fracture toughness reduces the weight factor of a damage and therefore leads to a lower effective damage. The depth z of each sub-surface damage 12 may for example be detected in a range of 0.5-50 mm below the surface 14, such as 0.5-20 mm or 1-20 mm below the surface 14.

According to a preferred embodiment, the step of performing non-destructive inspection may be performed for a plurality of portions of the bearing component, such as for a plurality of portions associated with the raceway surface 14 of the bearing component 1, wherein the remining bearing life calculation is done for the portion 12 having a maximum effective damage D. Thereby, by basing the remaining life calculation on the portion 10 with the maximum effective damage, a more accurate result of the remaining life can be obtained.

The remaining life may be calculated based on the following formula:

$$N = {c}^{⋆} {D}^{α}$$

wherein N is the remaining life, such as a remaining number of predicted revolutions, until reaching end of life of the bearing component 1, c is a first constant value associated with the predetermined load value, D is the effective damage and a is a second constant value.

The value N may for example be expressed in tens, hundreds, thousands or millions of remaining revolutions. Alternatively, as another example, the unit N may be expressed in a predicted time until reaching end of life if the rotational speed is known.

The constant values, c and a, are preferably obtained empirically by:
performing the step of non-destructive inspection for a plurality of test bearing components under known and different load conditions and for test bearing components with different initial sub-surface damage, and,
measuring remaining life for the plurality of test bearing components by testing the plurality of test bearing components until sub-surface failure occurs.

Thereby, remaining life for different load conditions as a function of effective damage D can be obtained. This may be plotted as curves for different load conditions as shown in FIG. 2. More specifically, FIG. 2 shows a graph where the remaining bearing life is indicated on the y-axis and where the effective damage D is indicated on the x-axis. In the shown example, three curves, one curve for a respective load situation, are plotted in the graph. The load conditions are relative load conditions, i.e. a low load condition, a medium load condition and a high load condition. The shown curves may be provided by interpolation between the empirically obtained values, and/or by use of a polynomial curve fit on the empirically obtained values.

The non-destructive inspection for each test bearing component may be performed before, during and after the respective component has been tested, thereby obtaining results indicative of an effective damage of each test bearing component before, during and after each test. This in turn may further improve the quality of the plotted curves, e.g. the constant values c and α may thereby be further improved.

It shall be understood that the calculated remaining life is an estimation of the remaining life. However, this estimation, by using detected sub-surface damages, has shown to be a good indication of the actual remaining life of a bearing component. As such, it can advantageously be used for taking manufacturing decisions on which bearings or bearing components that should be re-manufactured.

FIG. 4b depicts a method according to the second aspect of the disclosure. The method is a method for re-manufacturing a bearing component 1, 2, 3, comprising:
S10: performing the method according to any one of the embodiments of the first aspect of the disclosure for a bearing component, and
   when the bearing component 1, 2, 3 is selected as a candidate bearing component to be re-manufactured,
S20: re-manufacturing the selected bearing component 1, such as re-manufacturing a raceway surface 14 of the selected bearing component 1.

According to the fifth aspect of the disclosure, a method for calculating remaining life of a bearing component is provided. As such, again with reference to FIG. 4a, a method may be provided which comprises:
S1: performing a non-destructive inspection of at least one portion 10 of a bearing component 1, wherein the non-destructive inspection comprises detecting sub-surface damages 12 in the at least one portion 10, thereby obtaining a result indicative of an effective damage in the at least one portion 10, and
S2: calculating a remaining life of the bearing component 1 based on a predetermined load value and on the result indicative of the effective damage D in the at least one portion 10.

As such, according to the fifth aspect of the disclosure, the step S3 has been omitted, which is indicated by the dashed lined box in FIG. 4a. Accordingly, step S3 may be an optional step.

It is to be understood that the present disclosure is not limited to the embodiments described above and illustrated in the drawings; rather, the skilled person will recognize that many changes and modifications may be made within the scope of the appended claims.

1. A method for selecting a candidate bearing component to be re-manufactured, comprising:
performing a non-destructive inspection of at least one portion of a bearing component to detect sub-surface damages in the at least one portion and obtain a result indicative of an effective damage in the at least one portion,
calculating a remaining life of the bearing component based on a predetermined load value and on the result indicative of the effective damage in the at least one portion, and
selecting the bearing component as the candidate bearing component to be re-manufactured if the calculated remaining life is within a predefined range,
wherein the remaining life is calculated from the formula:
$$\underline{N = {c}^{⋆} {D}^{α}}$$
where N is the remaining life until reaching end of life of the bearing component, c is a first constant value associated with the predetermined load value, D is the effective damage and α is a second constant value.

2. The method according to claim 1, wherein each detected sub-surface damage is associated with a depth of the damage below the surface and a voluminal size of the damage.

3. The method according to claim 2, wherein the result indicative of the effective damage is obtained by summing the voluminal sizes of the damages multiplied by an associated weight factor, wherein the associated weight factor is dependent on the depth and size of the damages.

4. The method according to claim 3, wherein the associated weight factor is further dependent on a fracture toughness of a material of the bearing component.

5. The method according to claim 1, wherein performing non-destructive inspection comprises performing non-destructive inspection for a plurality of portions of the bearing component, and wherein the remining bearing life calculation is done for a portion of the plurality of portions that has a maximum effective damage.

6. (canceled)

7. The method according to claim 1, wherein the constant values, c and a, are obtained empirically by:
performing the step of non-destructive inspection for a plurality of test bearing components under known and different load conditions and for test bearing components with different initial sub-surface damage, and,
measuring remaining life for the plurality of test bearing components by testing the plurality of test bearing components until sub-surface failure occurs.

8. The method according to claim 7, wherein the non-destructive inspection for each test bearing component is performed before, during and after the respective component has been tested, thereby obtaining results indicative of an effective damage of each test bearing component before, during and after each test.

9. A method for re-manufacturing a bearing component, comprising:
performing the method according to claim 1, and
re-manufacturing the candidate bearing component.

10. (canceled)

11. The method according to claim 1,
wherein the remaining useful life comprises a predicted number of remaining revolutions.

12. The method according to claim 1,
wherein the at least one portion of the bearing component comprises a raceway of the bearing component.

13. The method according to claim 5,
wherein the plurality of portions of the bearing component comprise a plurality of portions associated with a raceway surface of the bearing component.

14. The method according to claim 9,
wherein re-manufacturing the candidate bearing component comprises re-manufacturing a raceway surface of the candidate bearing component.
